(19) United States
(12) Patent Application Publication
(10) Pub. No.: US 2005/0120375 A1
(43) Pub. Date: Jun. 2, 2005

(54) Wireless extension arrangement for a communications system

(75) Inventor: Scott Anthony Elms, Rainbow Beach (AU)

Correspondence Address: YOUNG & THOMPSON, 745 SOUTH 23RD STREET, 2ND FLOOR, ARLINGTON, VA, 22202, US

(73) Assignee: Interax Interactive Television, Queensland (AU)

(21) Appl. No.: 10/505,755

(22) PCT Filed: Feb. 26, 2003
(86) PCT No.: PCT/AU03/00236

(30) Foreign Application Priority Data
Feb. 26, 2002 (AU) PS 0754

(51) Int. Cl. H04N 7/173; H04N 7/18

(52) U.S. Cl. 725/81; 725/106

(57) ABSTRACT

Provided is a wireless extension arrangement 10 for a communications system having a telephone network 30. The arrangement 10 comprises one or more first transceiver units, 14 each said first transceiver unit having a state supervision means 70, 71, 73 and being associated with at least one communications apparatus 60, and a second transceiver unit 16 arranged for wireless communication with the or each said first transceiver unit 14. The supervision means 70, 71, 73 is arranged to generate a dial tone when an associated communications apparatus 60 is in an off hook state, and a ring tone when receiving a ring control signal from said second transceiver unit 16. The second transceiver unit 16 is adapted for connection to at least one remote communications terminal accessible over the telephone network 60. The first transceiver units 14 and the second transceiver unit 16 are arranged to transfer first communications signals between said at least one communications apparatus and said at least one remote communications terminal through said wireless communication and over the telephone network 30. The arrangement 10 further includes at least one communications signal source from which second communications signals are transmitted over a communications network such as a television network for reception by any of the at least one communications apparatus.

### TECHNICAL FIELD OF THE INVENTION

THIS INVENTION relates to a wireless extension arrangement for a communications system, and in particular but not limited to, the wireless extension arrangement is for an interactive digital television system which transmits information signals for reception by receivers over a television transmission network and is adapted to receive viewer response signals over a telephone network.

### BACKGROUND OF THE INVENTION

Communications systems such as digital television networks and computer networks (e.g. the Internet) allow bi-directional communication between suppliers and users. They are therefore interactive as the users may respond to any information provided by the suppliers over the communications systems.

Many corporations are taking advantage of the interactive nature of the communications systems to promote their businesses and offer for purchase their products and services over the interactive communications systems. Users of the communications systems are encouraged to interactively provide responses such as making inquiries and placing orders over the communications systems.

Digital television systems generally have local repeater stations for receiving user responses and forwarding the received responses to a response data centre for distribution to providers. Each repeater station is dedicated to receive responses from users or viewers in a small local area as its reception and capacity are limited. The users or viewers send responses to their respective repeater stations by using their response units to transmit response signals over a radio frequency channel such as a 218 MHz channel. One such system is disclosed in Morales' U.S. Pat. No. 5,872,589.

The above interactive television system is costly to set up and maintain, as it requires a large number of repeater stations and response units that must have sufficient transmission power to ensure reception at the repeater stations.

In most homes, television sets are located in living rooms, and telephones and their connection sockets are located away from the living rooms. If interactive response signals are to be sent over the telephone lines, telephone extension lines need to be installed to allow telephone sockets to be positioned close to the television sets.

Other home or office equipment such as computers, facsimile machines, telephone and telephone related systems, debit and/or credit card processing machines, and the like must be physically connected to telephone outlets if they are to be accessed from a remote equipment. In addition, there are proposals to produce electronic and electrical appliances that can be controlled from a remote computer or telephone. These will require new telephone lines and/or outlets.

In Australia three out of every ten families live in rented dwellings. They are reluctant to invest a substantial sum of money for a new telephone socket which cannot be taken away when they leave these dwellings. In addition some land lords may not approve of telephone sockets in sitting rooms. Other families, while they do not have the problem of seeking approval, may be reluctant to invest in new telephone sockets just to use the interactive component of the television systems. The long waiting period of about ten working days for telephone workers to install the new telephone sockets does not encourage families to decide on installing new telephone sockets which are to be used exclusively for interactive responses to a small proportion of television promotions.

For countries that are to, or just started to, adopt a television system that allows interactivity, the costs of installing repeater stations or extension telephone lines and sockets alone will be considerable. Also the take up rate of people using the interactivity will be slow due to the added costs of telephone extension line installation.

The Internet is another interactive communications system that allows computer users to access information that can be retrieved from web sites located any where in the world. As most of the Internet users connect to their Internet service provider networks using standard telephone lines which have limited bandwidth, the speed of sending and receiving information can be very slow. In fact the speed of information transfer deteriorates further when more people are using the same Internet service providers. Accordingly there is a desire to find a communications system that allows improved transfer of information for Internet users.

### OBJECT OF THE INVENTION

It is an object of the present invention to alleviate or to reduce to a certain level one or more of the above disadvantages.

### SUMMARY OF THE INVENTION

In one aspect, therefore, the present invention resides in a wireless extension arrangement for a communications system having a telephone network. The arrangement of the present invention comprises one or more first transceiver units, each said first transceiver unit having a state supervision means and being associated with at least one communications apparatus, and a second transceiver unit arranged for wireless communication with the or each said first transceiver unit. The supervision means is arranged to generate a dial tone when an associated communications apparatus is in an off hook state, and a ring tone when receiving a ring control signal from said second transceiver unit. The second transceiver unit is adapted for connection to at least one remote communications terminal accessible over a telephone network. The first transceiver unit(s) and the second transceiver unit are arranged to transfer first communications signals between said at least one communications apparatus and said at least one remote communications terminal through said wireless communication and over the telephone network.

In preference, the arrangement further includes at least one communications signal source from which second communications signals are transmitted over a communications network for reception by any of the at least one communications apparatus.

The supervision means may be arranged to generate an on hook control signal for indicating to the second transceiver unit that the communications apparatus is returned to the on hook state. It is preferred that the supervision means is a subscriber line interface circuit (SLIC).

The second transceiver unit may have control means arranged to transmit said ring control signal when a ring signal is detected on said telephone network. It is preferred that the control means is a subscriber line interface circuit (SLIC) or a central office interface circuit (COID) or a data access arrangement (DAA) or any combination thereof.

The arrangement of the present invention may have configuration means for selectively configuring operation parameters of the at least one transceiver unit and the second transceiver unit. The parameters may include a unique unit identification for the transceiver units so that the first transceiver unit(s) can communicate only with the second transceiver unit with the same unit identification. The parameters may also include equipment type identifications for the second transceiver unit to transfer communication signals of a particular equipment type only to the first transceiver unit associated with the communications apparatus of the particular equipment type. The parameters can also include a frequency channel for communication, an Internet protocol (IP) address, group identification, etc.

In preference, the first transceiver unit(s) has a networking circuit arranged for the associated communications apparatus to be connectable to a local or wide area network.

It is also preferred that the second transceiver unit has a modem facility so that any of the communications apparatus can access the Internet.

The first communications signals may include any one or more of data signals, telephone signals, facsimile signals, audio signals, video signals, radio signals, television signals, appliance control signals, and the like.

In preference said communications system is a digital communications system. The communications system may be adapted for transmitting information signals for radio, and/or television broadcasting, and/or Internet web pages.

The at least one communications source may be a radio station, a television station, a computer, a telephone, a facsimile machine or an Internet computer server. Preferably said at least one communications source is an integrated source including two or more of the radio station, the television station, the computer, the telephone, the facsimile machine and the Internet computer server.

The communications network maybe a radio frequency (RF) communications network including a digital television network, a cable television network, a telephone network or the Internet.

The at least one communications apparatus can be a computer, a television receiver or a radio receiver, a facsimile machine, a telephone, an air conditioner, a refrigerator, a freezer, a cooking equipment, an electronic account processing machine, or the like. Desirably the at least one communications apparatus is a television receiver or a computer, having a decoder module adapted to decode said first communications signals. It is preferred that said first communications signals include signals for television and signals for Internet web pages, and the decoder module is arranged to decode both the television signals and the web page signals.

Advantageously the at least one communications apparatus includes a storage member arranged to store the decoded communications signals, and the communications apparatus is arranged for a user to selectively retrieve any of said stored signals.

The at least one communications apparatus can be arranged to selectively indicate the television signals and the web page signals. Desirably the computer or the television receiver is arranged so that the television signals and the web page signals can be selectively indicated on its screen. More desirably the computer or the television receiver is arranged to indicate the television signals and the web page signals together in same or separate windows on the screen.

Typically the or each of said one or more first transceiver units, and the second transceiver unit include a receiver module for receiving RF or optical signals, a transmitter module for transmitting RF or optical signals, and a signal processing module for processing signals. The RF signals may be arranged for communication under the Bluetooth protocol.

The signal processing module may include a modulator for modulating signals for transmission by said transmitter module, and a demodulator for demodulating signals from said receiver module. Desirably the signal processing module has a signal coding arrangement for encoding signals for transmission and for decoding received signals. The signal processing module may also include a signal separation arrangement for separating incoming signals and outgoing signals.

The at least one communications apparatus may have a casing. Said decoder module can be provided within the casing or in a set top box adapted for connection to the at least one communications apparatus. Typically the decoder module is arranged for connection to an antenna or the telephone network for receiving said first information signal.

A modem may be arranged to convert between digital signals and analogue signals so that the arrangement can communicate with communications networks in different signal form.

Similarly said storage member may be provided within the casing or the set top box.

The or any two or more of the one or more first transceiver units may be integrated within said set top box or arranged for connection to said set top box.

Advantageously, the or each of the one or more first transceivers unit has a housing and first signal processing means located in the housing. The housing includes an interface for connecting the or one of the at least one communications apparatus to the processing means, and means for supplying power to the unit. The power supplying means may include a battery module and/or a solar power module and/or connector module for connection to an external power source. The external power source may include telephone line power or electricity power. The battery module and/or solar power module can be arranged to be positionable in the housing. The connector module may include power connectors extending from the housing and the power connectors are arranged for connection to an electricity power outlet.

The second transceiver unit may also have a housing and second signal processing means located in the housing. This housing includes an interface for connecting the processing means to the at least one information source, and means for supplying power to the second unit. The power supplying means for the second unit may include a battery module and/or a solar power module and/or connector module for connection to an external power source. The external power source may include telephone line power or electricity power. The battery module and/or solar power module can be arranged to be positionable in the housing. The connector module may include power connectors extending from the housing and the power connectors are arranged for connection to an electricity power outlet.

The arrangement of the present invention typically has a controller unit for selectively controlling outgoing signals for transmission from the one or more first transceiver unit. The controller unit may have a direct wired or wireless connection with the or each of the first transceiver unit, or a connection through the second transceiver unit. The wireless connection between the controller unit and the or each of the first transceiver unit may be in the form of RF or infrared.

In preference said controller unit has a keyboard for entering data for transmission as the out going signals to the first transceiver unit. The controller unit may also have a pointing device such as a mouse for selecting icons or data on the said at least one communications apparatus.

### BRIEF DESCRIPTION OF THE DRAWINGS

In order that the present invention can be more readily understood and be put into practical effect reference will now be made to the accompanying drawings which illustrate embodiments of the present invention and wherein:

FIG. 1 is a schematic view of one embodiment of the arrangement according to the present invention;

FIG. 2 is a block diagram of another embodiment of the arrangement according to the present invention;

FIG. 3 shows certain components in an embodiment of the transceiver unit of the arrangement according to the present invention;

FIG. 4 shows a further embodiment of the arrangement according to the present invention;

FIG. 5 is a schematic drawing showing some applications of the arrangement shown in FIG. 4;

FIG. 6 shows another further embodiment of the arrangement according to the present invention;

FIG. 7 shows a circuit board layout of an embodiment of the second transceiver;

FIG. 8 shows a circuit board layout of an embodiment of the first transceiver;

FIG. 9 is a block diagram of an embodiment of the second transceiver unit for communicating in the Bluetooth protocol;

FIG. 10 is a block diagram of an embodiment of the first transceiver unit for communicating in the Bluetooth protocol; and

FIG. 11 is a flow diagram of the steps for an example of the parameter configuration process.

### DETAILED DESCRIPTION OF THE INVENTION

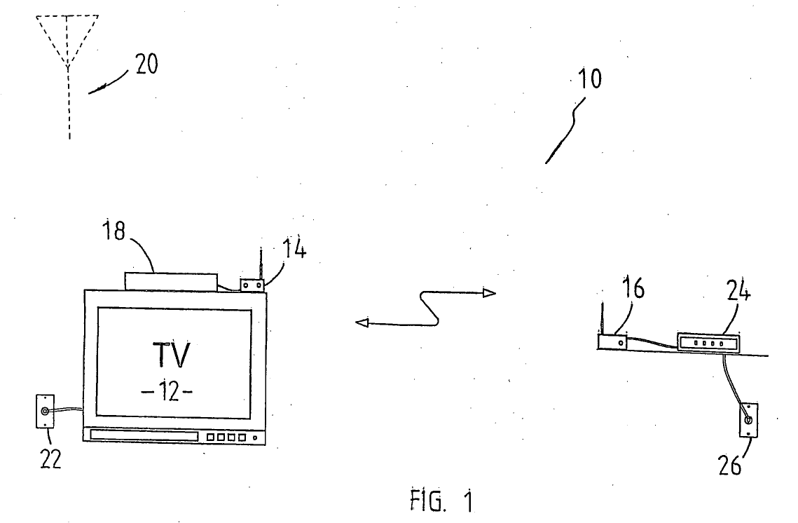

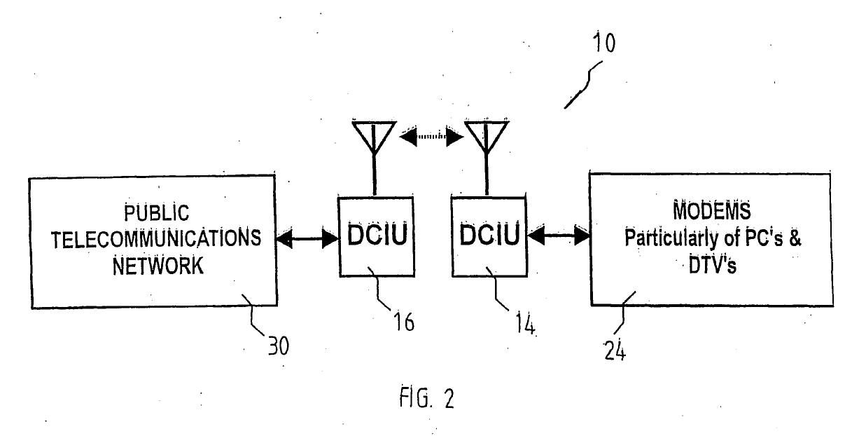

Referring to the Figures and initially to FIG. 1 there is shown a wireless extension arrangement 10 for communicating signals from a television receiver (TV) 12 to a remote communications terminal (not shown) over a telephone network (30 in FIG. 2). TV 12 in this case is located in a sitting room in a residential building.

The arrangement 10 has a first transceiver unit 14 which in this case is a digital cordless interface unit (DCIU) and a second transceiver unit 16 which in this case is also a digital cordless interface unit (DCIU). DCIUs 14 and 16 communicates in a RF band that does not interfere with reception of TV 12.

TV 12 has a set top box 18 for receiving digital information signals in the forms of television programs and Internet web pages. The set top box 18 is connected to an external antenna 20 through an antenna connection 22.

DCIU 14 is connected to an output port of the set top unit 18 and a viewer can selectively enter data for to be provided at the output port by means of a remote infrared controller (not shown).

DCIU 14 relays the digital data at the output port of the set top unit 18 to DCIU 16 which is located in a different room in the building. DCIU 16 is connected to a modem 24 for converting the data to an analogue form for transmission over the telephone network 30 which is an analogue network. A wall telephone socket 26 is used to connect the modem 24 to the telephone network 30.

DCIU 14 may be incorporated into the set top unit 18 or arranged for wireless communications with the set top unit 18. Alternatively, the set top unit 18 can be arranged in wireless communication with TV12. The modem 24 as shown in FIG. 1 will not be needed if the telephone network 30 is for digital communications.

In FIG. 2 a modem 24 is connected between a digital television or a computer and DCIU 14 as DCIUs 14 and 16 are adapted for communicating analogue incoming and outgoing signals.

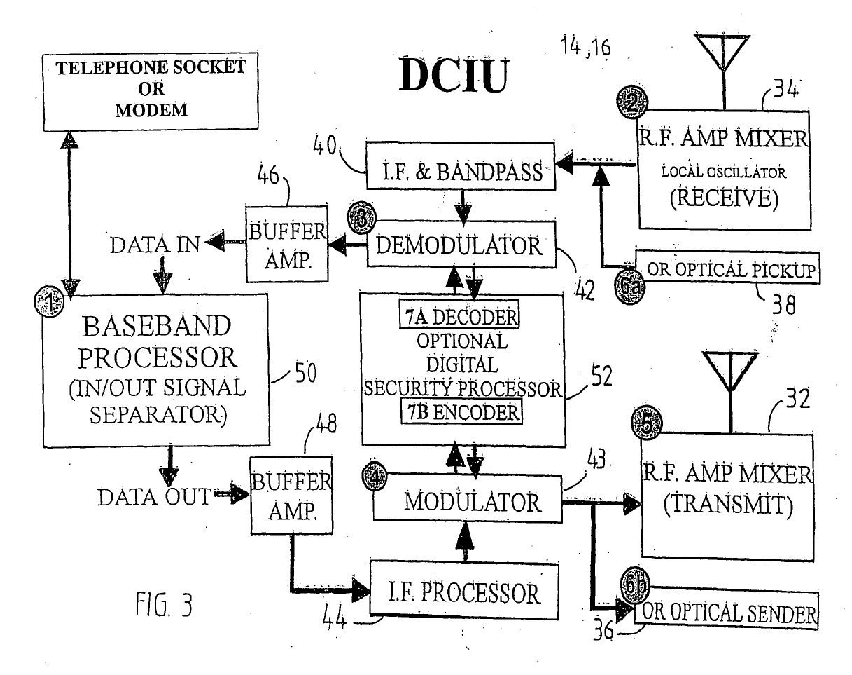

As shown in FIG. 3 each of the DCIUs 14 and 16 has a transmitter module 32 for transmitting data signals to other DCIU 16 or 14, and a receiver module 34 for receiving data signals transmitted from the transmitter module 32 of the DCIU 16 or 14. A tuned RF mixer is provided in each said modules 32 and 34 so that only signals within a specific frequency band can communicate there between. Alternatively the modules 32 and 34 can be replaced by optical sender 36 and optical pickup 38.

The transmitter module 32 and the receiver module 34 are connected to a signal processing module which, on the receiving part, has an intermediate frequency (IF) bandpass filter circuit 40 for filtering carrier frequency of the data signals from the receiver module 34, and a demodulator 42 for demodulating said filtered data signals. On the transmission part, it has an IF processing circuit 44 for mixing IF with outgoing data signals and a modulator 43 for modulating the mixed signals before transmission. Buffer amplifiers 46 and 48 are provided for buffering respective demodulated (incoming) data signals and the outgoing data signals.

A coding arrangement 52 is also provided for encoding data signals for transmission and for decoding received signals. The arrangement 52 gives certain security to transferring sensitive information such as credit card details as any intercepted signal will need to be decoded before its data is known.

The information signals from the TV 12 or the remote communications terminal and the incoming data signals are separated in a signal separation circuit 50 for separating signals for forwarding to TV 12 or the remote terminal, and signals for transmission by the transmitter module 32.

The arrangement 10 of the present invention thus allows users to provide interactive responses to invitations on television receivers or computers without having to install costly extension telephone lines and sockets. The television receivers or computers can be located in any convenient locations in a home, and they can be moved from location to location without the need to have new extension telephone lines and sockets.

The arrangement 10 also allow broadcasters and datacasters to obtain interactive responses via standard telephone networks and the Internet. This represents a large cost savings as repeater stations are not required. For Internet users downloading of information and programs will be much quicker as television bandwidths allow separate channels for Internet applications.

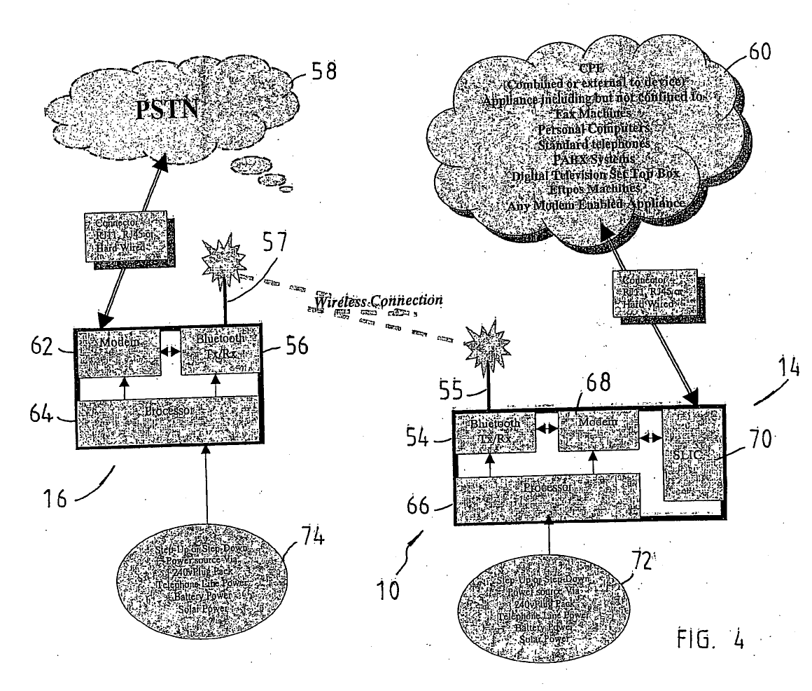

The embodiment of the arrangement 10 shown in FIG. 4 has a first transceiver unit 14 adapted for wireless communication with a second transceiver unit 16. The first transceiver unit 14 and the second transceiver unit 16 for this embodiment of the invention are configured for Bluetooth communications, and in this respect the unit 14 has a Bluetooth enabled transceiver module 54 and the unit 16 has a Bluetooth enabled transceiver module 56.

The Bluetooth enabled transceiver module 56 communicates signals received from information or communications sources (not shown) over the telephone network PSTN to a designated one of the appliances 60, and vice versa. An antenna 55 and an antenna 57 are connected to the respective unis 14 and 16 for extending communications range thereof. To receive signals from the communications sources the unit 16 is provided with a modem 62 which is under control of a processor 64. The processor 64 also controls the transceiver module 56. The modem 62 is connected to the PSTN using standard telephone connectors.

Similarly, the unit 14 has a modem 68 connected to the module 54 and a processor 66 for controlling operations of the module 54 and the modem 68. The unit 14 further includes a subscriber line interface circuit (SLIC) 70 for transferring signals to and from the appliances 60. Power sources 72 and 74 for the respective units 14 and 16 may be any one of the known power supply as indicated in FIG. 4.

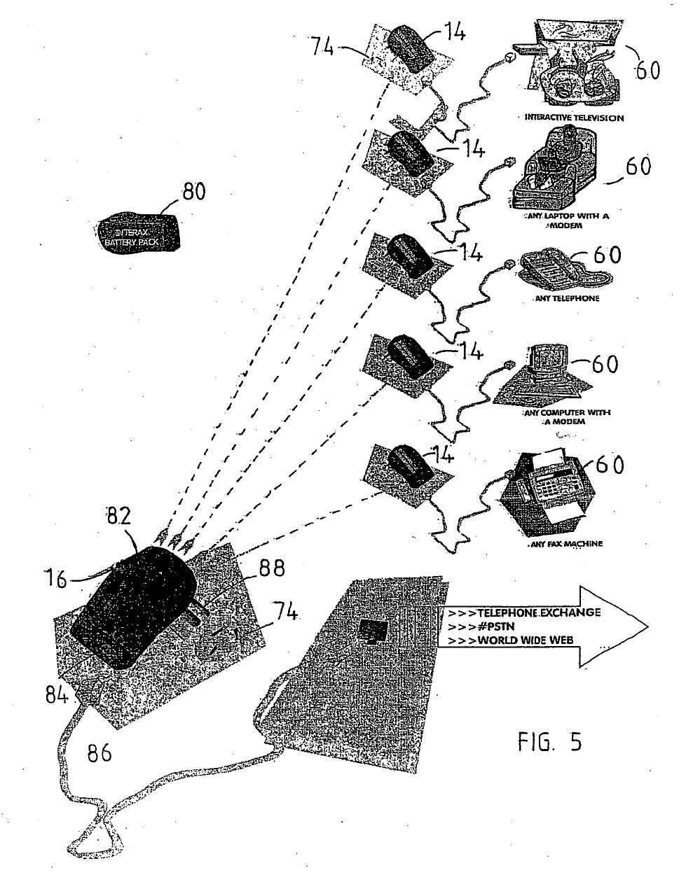

FIG. 5 shows a preferred form of the units 14 and 16 as described earlier. As can be seen, each of the units 14 and 16 has a housing 82 in which the components thereof are located. The housing has an opening 84 for connection of an RJ11 or RJ45 connector 86 to a standard telephone interface in the housing 82. Power connector prongs 88 extend from the housing 82for connection to a standard power supply outlet 74.

The arrangement 10 has a power pack 80 to provide power to the unit 14 or 16 so that arrangement 10 can be used in places where a power outlet 74 is not available and the power pack 80 can function as a standby power source in the event of power outage.

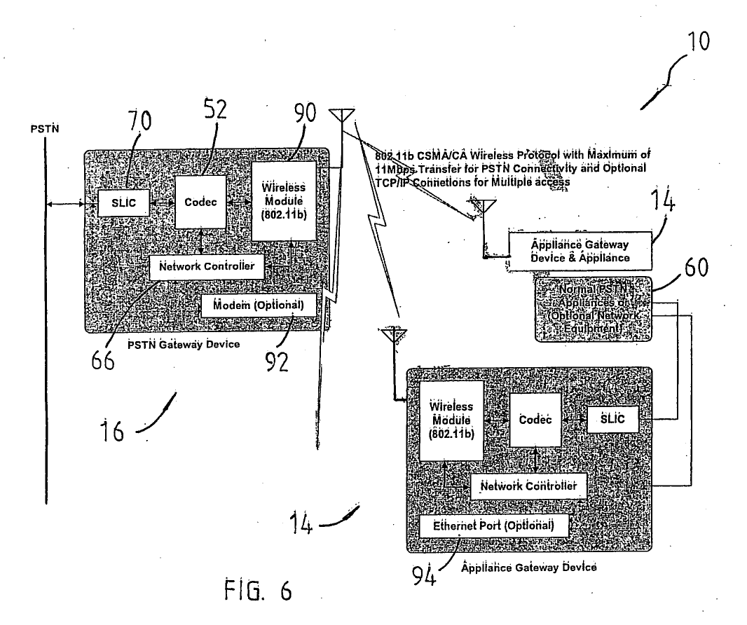

Referring now to FIG. 6, the arrangement 10 has a number of first transceiver units 14 called appliance gateway devices (AGD) and a second transceiver unit 16 called a PSTN gateway device (PGD). Each of the AGDs 14 is associated with an electronic appliance or communications apparatus 60. The AGDs 14 and the PGD 16 have a wireless module 90, a CODEC 52, a network controller 66 and a SLIC 70. The PGD 16, in this case, also has a modem 92 to enable the appliances 60 to access the Internet and any online communications service. The AGDs 14 has an Ethernet port 94 for connection to a computer network.

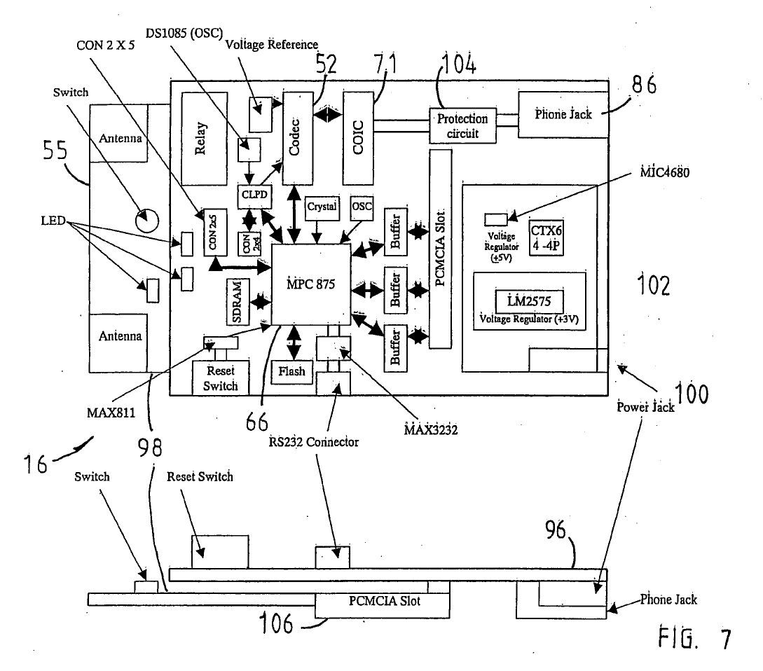

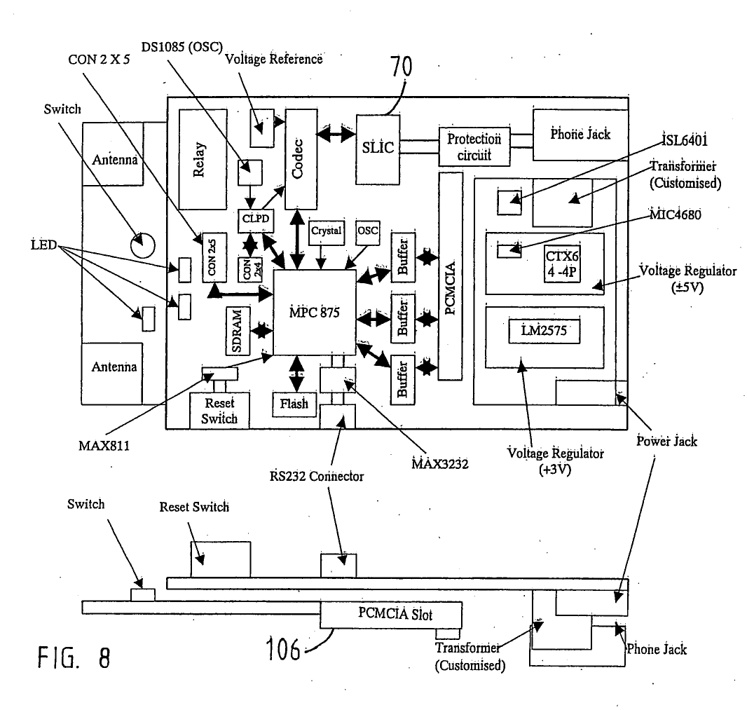

FIG. 7 shows certain components of an embodiment of the PGD 16 arranged on printed circuit boards 96 and 98. The components as shown include COIC 71, CODEC 52, a power jack 100 for connection to a power supply, a voltage regulator 102 for regulating voltages to the components, memory modules in the form of Flash, SDRAM, and buffer, antenna 55 and controller 66 in the form of MPC 875. A protection circuit 104 is provided for protecting the components from power surge in the telephone line. LEDs are provided to indicate operating states, and a reset switch is provide to reset the device to default operation parameters. A PCMCIA slot 106 is used for programming optional applications of the device. The AGD 14 boards as shown in FIG. 8 are populated with components similar to those in the PGD 16, except that it has SLIC 70 instead of the COID 71.

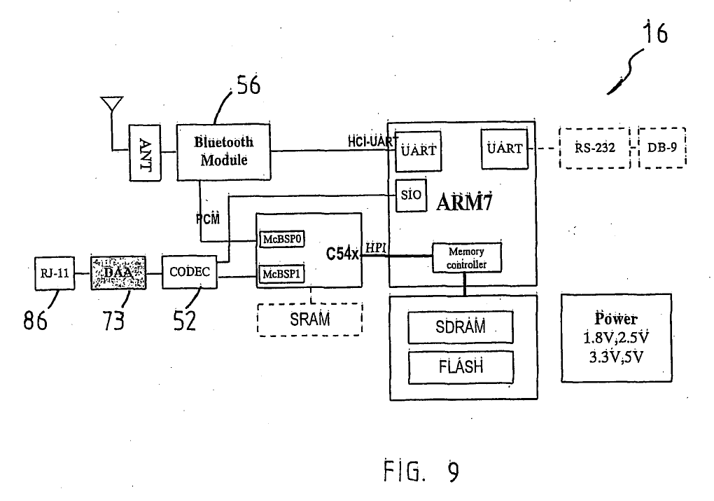

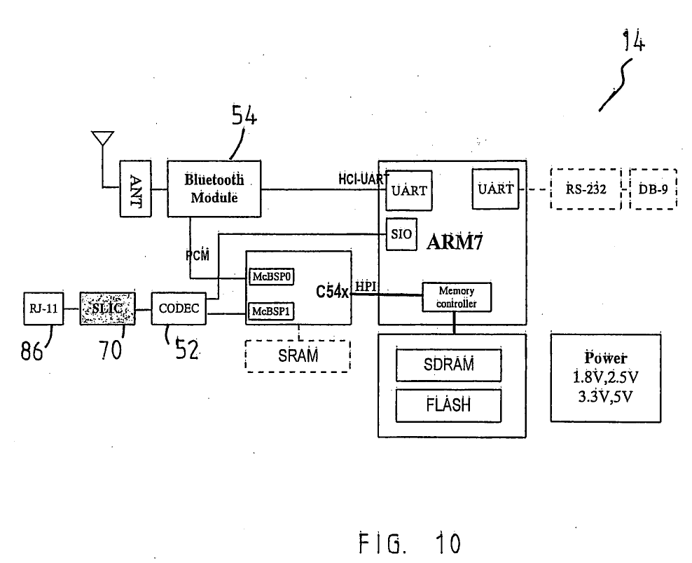

FIGS. 9 and 10 show block diagrams of another embodiment of the Bluetooth enabled PGD 16 and AGD 14.

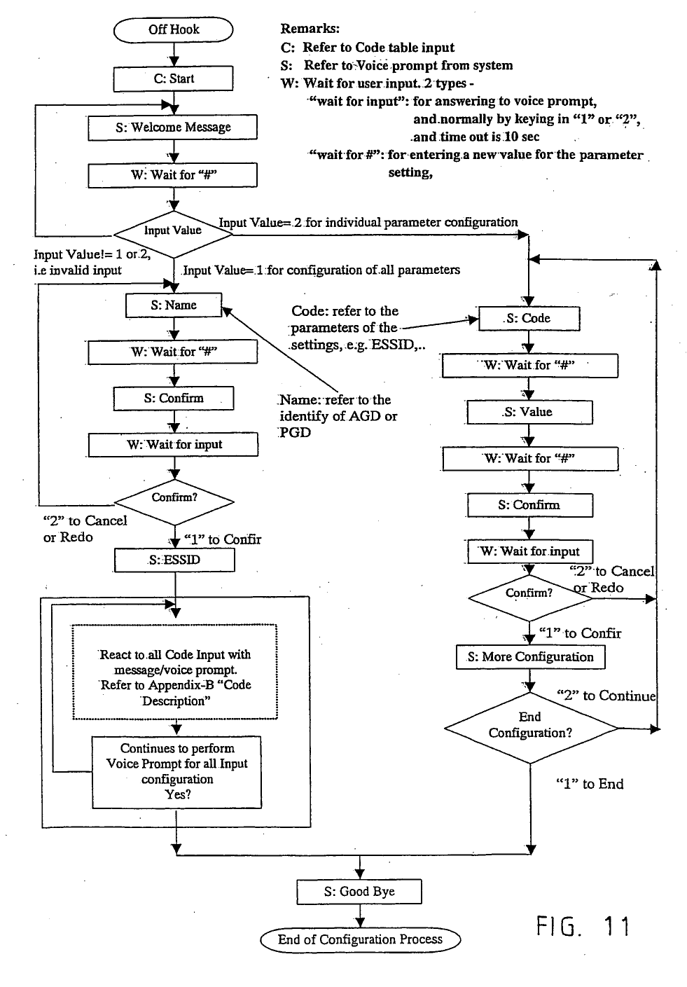

The PGD 16 and the AGDs 14 have default operation parameters and operation parameters which can be configured by users. FIG. 11 shows steps in configurating the parameters as shown in the following tables The configuration process may have voice and/or text based prompts for users to enter details.

TABLE A
Voice Prompt: Message Description

| Code | Description |
|---|---|
| Name | The individual identify of the PGD (and also AGD) |
| ESSID | Extended Service Set Identifier, is a unique ID for the entire |
| | Interax Gateway Device System, i.e. PGD and all its |
| | respective AGD clients must have the same ESSID for |
| | identify as subnet of communication topology |
| WEP | Wired Equivalent Privacy, it is the communication encryption |
| | parameters for secure communication within the |
| | communication subnet |
| IP | Internet Protocol Address. IP Address will allow all multicast |
| Address | and point-to-point communication to be within the network |
| | environment, and also be allowed to have unique address for |
| | data communication. |
| SubNet | Subnet mask is for communication to be restricted within the |
| | communication layer, and allow for addition of other |
| | communication devices. |
| Channel | There are a total of communication Channels for selection. |
| | Basically channel 1 to 13, and each channel represent one |
| | unique frequency with in the 2.4˜2.4835 GHz ISM band. For |
| | which each channel is occupying a total of 25 MHz of |
| | bandwidth |

TABLE B
PGD Parameter Setting

| S/N | Code | Name | Input Description | Remark |
|---|---|---|---|---|
| 1 | Name | 901 | Input Value {0, 1, . . . 9} | |
| | | | Example: 1234 or 34567 or . . . | |
| | | | (limited to 5 characters input) | |
| 2 | ESSID | 902 | Input Value {0, 1, . . . 9} | |
| | | | Example: 9190 or 13467 or . . . | |
| | | | (limited to 5 characters input) | |
| 3 | WEP | 903 | Input Value {0, 1, . . . 9} | |
| | | | Example: 11111 or 12345 or . . . (5 | |
| | | | characters input) | |
| 4 | IP | 904 | Input Value {0, 1, . . . 9} | both “xxx” |
| | Address | | Input Pattern: xxx.xxx.xxx.yyy, | & “yyy” not |
| | | | where x, y are numeric input | larger than |
| | | | Example: 192.168.001.001 or | 255 |
| | | | 192.168.002.001 or . . . | |
| 5 | SubNet | 905 | Input Value {0, 1, . . . 9} | “***” not |
| | | | Input Pattern: ***.***.***.***, | larger than |
| | | | where * is numeric input | 255 |
| | | | Example: 255.255.255.000 or . . . | |
| 6 | Channel | 906 | Input Value {0, 1, 2, . . . 13} | input number |
| | | | | not larger |
| | | | | than 13 |

TABLE C
AGD Parameter Setting

| S/N | Code | Name | Input Description | Remark |
|---|---|---|---|---|
| 1 | Name | 901 | Input Value {0, 1, . . . 9} | |
| | | | Example: 1234 or 34567 or . . . | |
| | | | (limited to 5 characters input) | |
| 2 | ESSID | 902 | Input Value {0, 1, . . . 9} | |
| | | | Example: 9190 or 13467 or . . . | |
| | | | (limited to 5 characters input) | |
| 3 | WEP | 903 | Input Value {0, 1, . . . 9} | |
| | | | Example: 11111 or 12345 | |
| | | | or . . . (5 characters input) | |
| 4 | IP | 904 | Input Value {0, 1, . . . 9} | “xxx” must be |
| | Address | | Input Pattern: xxx.xxx.xxx.yyy, | the same as |
| | | | where x, y are numeric input | PGD, and |
| | | | Example: 192.168.001.002 or | “yyy” must be |
| | | | 192.168.002.010 or . . . | different from |
| | | | | PGD & not |
| | | | | larger than |
| | | | | 255 |

TABLE D
General Input Description

| S/N | Code | Number Input | Description |
|---|---|---|---|
| 1 | Start | *# | Starting code for configuration |
| 2 | RA | 1 | Reconfiguration for All Parameters |
| 3 | IC | 2 | Individual Configuration Mode |
| 4 | C | 1 | Confirmation |
| 5 | NC | 2 | Reconfiguration or Cancel |
| 6 | End | 1 | End of operation |
| 7 | Yes | 1 | Yes |
| 8 | No | 2 | No |

TABLE E
Time-out Parameters

| S/N | Code | Time-out | Description |
|---|---|---|---|
| 1 | Wait for Input | 10 | Answering to question from voice |
| | | | prompt |
| 2 | Wait for # | 15 | Setting new value for parameter (e.g. |
| | | | ESSID . . . ) |

TABLE F
Voice Prompt: Message Description

| S/N | Code | Voice Prompt Message | Remark |
|---|---|---|---|
| 1 | Welcome | Welcome to Configuration Mode | |
| | | Press “1” for reconfiguration All | |
| | | Parameters | |
| | | Press “2” for Individual Parameters | |
| | | Configuration | |
| 2 | Name | Press enter “Name” and press “#” | Refer Appendix - B/C |
| | | to confirm | |
| 3 | ESSID | Please enter “ESSID” and press “#” | Refer Appendix - B/C |
| | | to confirm | |
| 4 | IP Address | Please enter “IP Address” and | Refer Appendix - B/C |
| | | press “#” to confirm | |
| 5 | SubNet | Please enter “SubNet” and press | Prefer Appendix - B |
| | | “#” to confirm | |
| 6 | WEP | Please enter “WEP” and press “#” | Refer Appendix - B/C |
| | | to confirm | |
| 8 | Channel | Please enter “Channel” and press | Refer Appendix - B |
| | | “#” to confirm | |
| 9 | Code | Please enter “Code” and press “#” | Refer Appendix - B/C |
| | | to confirm | |
| 10 | Value | Please enter “Value” and press “#” to | Refer Appendix - B/C |
| | | confirm | |
| 11 | Confirm | Voice Prompt on: Confirmation of “Code” | Refer Appendix - B/C |
| | | is “Value” | |
| | | Press “1” to confirm | |
| | | Press “2” to cancel and | |
| | | reconfiguration | |
| 12 | More | Please enter “IP Address”” and | Refer Appendix - B/C |
| | Configuration | press “#” to confirm | |
| | | Press “1” to End | |
| | | Press “2” to Continue with | |
| | | configuration | |
| 13 | Good Bye | New Configuration Set | |

Whilst the above has been given by way of illustrative example of the present invention many variations and modifications thereto will be apparent to those skilled in the art without departing from the broad ambit and scope of the invention as herein set forth.

1. A wireless extension arrangement for a communications system having a telephone network, including one or more first transceiver units, each said first transceiver unit having a state supervision means and being associated with at least one communications apparatus, and a second transceiver unit arranged for wireless communication with the or each said first transceiver unit, the supervision means being arranged to generate a dial tone when an associated communications apparatus is in an off hook state, and a ring tone when receiving a ring control signal from said second transceiver unit, the second transceiver unit being arranged for connection to at least one remote communications terminal accessible over a telephone network, the first transceiver unit(s) and the second transceiver unit being arranged to transfer first communications signals between said at least one communications apparatus and said at least one remote communications terminal through said wireless communication and over the telephone network.

2. The arrangement according to claim 1 further including at least one communications signal source from which second communications signals are transmitted over a communications network for reception by any of the at least one communications apparatus.

3. The arrangement according to claim 1 wherein the supervision means is arranged to generate an on hook control signal for indicating to the second transceiver unit that the communications apparatus has returned to the on hook state.

4. The arrangement according to claim 3 wherein the supervision means is a subscriber line interface circuit (SLIC).

5. The arrangement according to claim 1 wherein the second transceiver unit having control means arranged to transmit said ring control signal when a ring signal is detected on said telephone network.

6. The arrangement according to claim 5 wherein the control means is a subscriber line interface circuit (SLIC) or a central office interface circuit (COID) or a data access arrangement (DAA) or any combination thereof.

7. The arrangement according to claim 1 further including configuration means for selectively configuring operation parameters of the at least one transceiver unit and the second transceiver unit, the parameters including a unique unit identification for the transceiver units so that the first transceiver unit(s) can communicate only with the second transceiver unit with the same unit identification.

8. The arrangement according to claim 7 wherein the parameters further include equipment type identifications for the second transceiver unit to transfer communication signals of a particular equipment type only to the first transceiver unit associated with the communications apparatus of the particular equipment type.

9. The arrangement according to claim 7 wherein the parameters also include a frequency channel for communication by said first and second transceiver units, an Internet protocol (IP) address for identifying the first and second transceiver units, and group identification, for identifying a group of the first transceiver units.

10. The arrangement according to claim 1 wherein the first transceiver unit(s) has a networking circuit arranged for the associated communications apparatus to be connectable to a local or wide area network.

11. The arrangement according to claim 1 wherein the second transceiver unit has a modem facility so that any of the communications apparatus can access the Internet.

12. The arrangement according to claim 1 wherein The first communications signals including any one or more of data signals, telephone signals, facsimile signals, audio signals, video signals, radio signals, television signals, appliance control signals, and the like.

13. The arrangement according claim 1 wherein said communications system is a digital communications system.

14. The arrangement according to claim 1 wherein the communications system includes services relating to broadcasting information signals for radio, and/or television broadcasting, and/or Internet web pages.

15. The arrangement according to claim 2 wherein the at least one communications source is a radio station, a television station, a computer, a telephone, a facsimile machine or an Internet computer server.

16. The arrangement according to claim 15 wherein said at least one communications source is an integrated source including two or more of the radio station, the television station, the computer, the telephone, the facsimile machine and the Internet computer server.

17. The arrangement according to claim 1 wherein wherein the communications network is a radio frequency (RF) communications network including a digital television network, and/or a cable television network, and/or a telephone network and/or the Internet.

18. The arrangement according to claim 1 wherein the at least one communications apparatus includes a computer, and/or a television receiver and/or a radio receiver, and/or a facsimile machine, and/or a telephone, and/or an air conditioner, and/or a refrigerator, and/or a freezer, and/or a cooking equipment, and/or an electronic account processing machine, or the like.

19. The arrangement according to claim 18 wherein the at least one communications apparatus is a television receiver or a computer, having a decoder module adapted to decode said first communications signals, said first communications signals include signals for television and signals for Internet web pages, and the decoder module is arranged to decode both the television signals and the web page signals.

20. The arrangement according to claim 19 wherein the at least one communications apparatus includes a storage member arranged to store the decoded communications signals, and the communications apparatus is arranged for a user to selectively retrieve any of said stored signals.

21. The arrangement according to claim 1 wherein the or each of said one or more first transceiver units, and the second transceiver unit include a receiver module for receiving RF or optical signals, a transmitter module for transmitting RF or optical signals, and a signal processing module for processing signals.

22. The arrangement according to claim 21 wherein the first and second transceiver units are arranged for communication with the Bluetooth protocol.

23. The arrangement according to claim 21 wherein the signal processing module includes a modulator for modulating signals for transmission by said transmitter module, and a demodulator for demodulating signals from said receiver module, and the signal processing module having a signal coding arrangement for encoding signals for transmission and for decoding received signals.

24. The arrangement according to claim 1 wherein the or each of the one or more first transceivers unit, and the second transceiver unit, each having a housing and first signal processing means located in the housing, the housing including an interface for connecting the or one of the at least one communications apparatus to the processing means, and means for supplying power to the unit.

25. The arrangement according to claim 24 wherein the power supplying means includes a battery module and/or a solar power module and/or connector module for connection to an external power source.
